(19) United States
(12) Patent Application Publication
(10) Pub. No.: US 2013/0209195 A1
(43) Pub. Date: Aug. 15, 2013

(54) LINEAR OBJECT COMPOSED OF MAGNESIUM ALLOY, BOLT, NUT, AND WASHER

(71) Applicants: Tetsuya Kuwabara, Osaka-shi, Osaka (JP); Taichirou Nishikawa, Osaka-shi, Osaka (JP); Yoshihiro Nakai, Osaka-shi, Osaka (JP); Toru Tanji, Osaka-shi, Osaka (JP); Misato Kusakari, Osaka-shi, Osaka (JP)

(72) Inventors: Tetsuya Kuwabara, Osaka-shi, Osaka (JP); Taichirou Nishikawa, Osaka-shi, Osaka (JP); Yoshihiro Nakai, Osaka-shi, Osaka (JP); Toru Tanji, Osaka-shi, Osaka (JP); Misato Kusakari, Osaka-shi, Osaka (JP)

(73) Assignee: SUMITOMO ELECTRIC INDUSTRIES, LTD., Osaka-shi, Osaka (JP)

(21) Appl. No.: 13/879,065

(22) PCT Filed: Oct. 3, 2011
(86) PCT No.: PCT/JP2011/072720

§ 371 Date: Apr. 12, 2013

(30) Foreign Application Priority Data
Oct. 12, 2010 (JP) 2010-229404

(51) Int. Cl. C22C 23/04; F16B 33/00; F16B 43/00; C22C 23/02

(52) U.S. Cl. CPC C22C 23/04; C22C 23/02; F16B 33/00; F16B 43/00
USPC 411/378; 420/411; 420/409; 411/427; 411/531

(57) ABSTRACT

A linear object is composed of a magnesium alloy including, in percent by mass, 0.1% to 6% of Zn, 0.4% to 4% of Ca, and the balance being Mg and incidental impurities, in which, when a creep test is performed on the linear object under conditions of a temperature of 150° C., a stress of 75 MPa, and a holding time of 100 hours, the linear object has a creep strain of 1.0% or less. Zn and Ca interact with each other to improve heat resistance, and thus it is possible to obtain the linear object having an excellent creep property. By incorporating Zn and Ca, in amounts in specific ranges, into the magnesium alloy, it is also possible to obtain the linear object having excellent plastic workability.

### TECHNICAL FIELD

The present invention relates to a linear object composed of a magnesium alloy, and a bolt, a nut, and a washer, each made from the linear object. More particularly, the invention relates to a linear object composed of a magnesium alloy which has excellent heat resistance and plastic workability and which is suitably used as a material for a fastener component, such as a bolt.

### BACKGROUND ART

Magnesium alloys are lighter than aluminum and have higher specific strength and higher specific rigidity than steel and aluminum. Therefore, it has been considered to use magnesium alloys as materials for various structural members, such as aircraft parts, car parts, and casings of electronic/electric appliances.

For example, PTL 1 proposes use of a magnesium alloy as a material for screws. PTL 1 discloses that a screw is produced by subjecting a wire (linear object) composed of a magnesium alloy, which is obtained by drawing an extruded material, to plastic working for screws, such as forge processing and forming by rolling.

Metal members can be fastened to each other using fastener components, such as screws and bolts. In this case, if the metal members and the fastener components are composed of different kinds of metals, or if the fastener components, such as bolts and nuts, are composed of different kinds of metals, there is a concern that electrical corrosion may occur between different kinds of metals, or, in a high-temperature environment, the fastened state may be loosened because of a difference in the amount of thermal expansion. Consequently, when members composed of a magnesium alloy are fastened to each other by fastener components, preferably, fastener components that are also composed of the magnesium alloy are used so that occurrence of electrical corrosion or loosening of the fastened state can be prevented. Furthermore, when the fastener components, such as bolts, are produced by using a linear object composed of a metal as a material and subjecting the material to plastic working, excellent productivity is achieved, which is desirable.

### CITATION LIST

### Patent Literature

PTL 1: Japanese Unexamined Patent Application Publication No. 2005-048278

### SUMMARY OF INVENTION

### Technical Problem

However, hitherto, no consideration has been given to linear objects composed of magnesium alloys which have excellent heat resistance and plastic workability that is suitable for a material for fastener components, such as bolts.

Some parts, such as aircraft parts and car parts, are used in a high-temperature environment. Consequently, fastener components composed of a magnesium alloy are also required to have excellent heat resistance, and thus, linear objects which are materials for the fastener components are also required to have excellent heat resistance.

On the other hand, magnesium alloys have poor plastic workability at room temperature (typically about 20° C.). Therefore, as described in PTL 1, plastic working is carried out by heating a material composed of a magnesium alloy to a temperature at which high plastic workability is achieved. Here, for example, improving the heat resistance of a linear object by adding an element having excellent heat resistance to the magnesium alloy may be considered. However, an increase in the amount of an additive element tends to degrade plastic workability. Even if the material is heated at the time of plastic working as described above, fractures or the like may occur in the material during plastic working, resulting in a decrease in productivity of the fastener component.

Accordingly, it is an object of the present invention to provide a linear object composed of a magnesium alloy which is excellent in terms of heat resistance and plastic workability. It is another object of the present invention to provide a bolt, a nut, and a washer having excellent heat resistance.

### Solution to Problem

The present inventors have found that, as a result of Ca and Zn being incorporated into a magnesium alloy in specific ranges, Ca and Zn interact with each other to improve heat resistance. Furthermore, the present inventors have found that, by incorporating Ca and Zn, in amounts in specific ranges, into a magnesium alloy, it is possible to reduce degradation of plastic workability caused by incorporation of additive elements in a linear object composed of the magnesium alloy, and that a linear object composed of the magnesium alloy having the specific composition can have plastic workability sufficient to produce a bolt or the like by plastic working. The present invention has been achieved on the basis of the findings described above.

According to the present invention, a linear object is composed of a magnesium alloy including 0.1% by mass or more and 6% by mass or less of Zn, more than 0.4% by mass and 4% by mass or less of Ca, and the balance being Mg and incidental impurities, the linear object having a 0.2% proof stress of 200 MPa or more and a tensile strength of 260 MPa or more, in which, when a creep test is performed on the linear object under conditions of a temperature of 150° C., a stress of 75 MPa, and a holding time of 100 hours, the creep strain is 1.0% or less.

The linear object composed of a magnesium alloy according to the present invention has a specific composition including Ca and Zn in specific ranges, and therefore, it has a small creep strain of 1.0% or less when the creep test is performed, thus exhibiting an excellent creep property. Consequently, the linear object of the present invention has excellent heat resistance. Furthermore, since the linear object of the present invention has the specific composition, it has excellent plastic workability, and it is possible to satisfactorily produce a fastener component, such as a bolt, a nut, or a washer, through production steps including plastic working. Consequently, the linear object of the present invention can be suitably used as a material for the fastener component, and in addition, as a material for secondary products which are subjected to various plastic working operations. Furthermore, since the fastener component can be produced by plastic working with a small amount of material removal (small material loss), by using the linear object of the present invention as a material, the fastener component can be produced with high productivity.

Furthermore, a fastener component obtained from the linear object of the present invention, i.e., a bolt of the present invention, a nut of the present invention, or a washer of the present invention obtained by subjecting the linear object of the present invention to plastic working, has excellent heat resistance. Consequently, by using the bolt of the present invention, the nut of the present invention, or the washer of the present invention, it is expected to maintain a strong fastened state over a long period of time even in use in a high-temperature environment. In particular, since the bolt of the present invention has excellent heat resistance, the axial force of the bolt can be increased even in use in a high-temperature environment, and thus, a strong fastened state can be maintained.

The present invention will be described below in more detail.

In the linear object of the present invention, heat resistance increases as the creep strain decreases. Accordingly, the creep strain is preferably 0.8% or less, and in particular, 0.5% or less.

Ca improves heat resistance and contributes to improving the creep property. When the Ca content is 0.4% by mass or less, the creep property is low. As the Ca content is increased, the creep property tends to be improved. However, in the case where Ca is contained at a high concentration, such as more than 0.4% by mass, in particular, 1% by mass or more, elongation tends to decrease, and fractures, breaking, and the like are likely to occur at the time of plastic working, such as a drawing process. It has been found that, for example, as will be described later, it is effective in reducing fractures, breaking, and the like at the time of plastic working to perform specific heat treatment on a cast material or specific intermediate heat treatment in the middle of a drawing process. Consequently, the linear object of the present invention contains Ca in an amount of more than 0.4% by mass. However, when the Ca content exceeds 4% by mass, plastic workability is degraded. Therefore, the Ca content is set at 4% by mass or less. More preferably, the Ca content is 0.5% by mass or more and 3.2% by mass or less.

Zn interacts with Ca to improve heat resistance and contributes to improving the creep property. When the Zn content is less than 0.1% by mass, the creep property is low. When the Zn content exceeds 6% by mass, plastic workability is degraded. More preferably, the Zn content is 1.0% by mass or more and 5.4% by mass or less.

The atomic ratio of Zn to Ca is preferably Zn:Ca=1:0.5 to 2, and in particular, Zn:Ca=1:0.8 to 1.5. When the atomic ratio satisfies the range described above, it is expected that the heat resistance improving effect due to the interaction between Zn and Ca will be more easily obtained. The atomic ratio can be obtained, for example, by determining the contents (mass) of the elements using inductively-coupled plasma emission spectrometry or the like and making calculations on the basis of the relationships between the atomic weight and mass of the elements.

Since the linear object of the present invention contains Ca and Zn in the specific ranges described above, excellent heat resistance and excellent plastic workability are exhibited. In the case where a magnesium alloy containing, in addition to Ca and Zn, at least one element selected from Al, Sn, Mn, Si, Zr, and Sr is used, it is possible to produce a linear object having excellent mechanical characteristics, casting performance, corrosion resistance, and the like, and by setting the contents of these elements in the specific ranges described below, it is possible to suppress degradation in plastic workability associated with incorporation of the elements. The contents, in percent by mass, of the elements are as follows: Al: 0.1% or more and 6% or less, Sn: 0.1% or more and 6% or less, Mn: 0.01% or more and 2% or less, Si: 0.01% or more and 2% or less, Zr: 0.01% or more and 4% or less, and Sr: 0.01% or less and 4% or less. Among the elements listed above, in particular, Zr has an effect of refining crystal grains, and it is possible to improve the strength of the magnesium alloy owing to the fine structure and to improve plastic workability. Mn has an effect of improving strength.

Note that the term “linear object” means an object having a diameter φ (in the case where the linear object has a non-circular cross section, such as a polygonal or elliptical cross section, the diameter of a circle that has the same area as that of the polygonal or elliptical cross section) of 13 mm or less and a length that is 100 or more times the diameter φ. Furthermore, examples of the linear object include long or fixed-length (cut to a predetermined length) bars, wire rods, tubes, and shapes with predetermined cross-sectional shapes and dimensions.

The linear object of the present invention is obtained by subjecting an appropriate material composed of a magnesium alloy having a specific composition to plastic working, such as a drawing process, an extrusion process, or a rolling process. Examples of the material to be subjected to plastic working include a cast material which is obtained by melting a magnesium alloy having a specific composition, and then casting the molten magnesium alloy in a casting mold having a predetermined shape, a heat-treated material obtained by subjecting a cast material having any shape to heat treatment (e.g., homogenization heat treatment, which will be described later), a rolled material obtained by subjecting a cast material or a heat-treated material having any shape to a rolling process, an extruded material obtained by subjecting a cast material or a heat-treated material having any shape to an extrusion process, and a drawn material obtained by subjecting a cast material or a heat-treated material having any shape to a drawing process. In particular, the linear object of the present invention is preferably one obtained by finally performing a drawing process.

The cast material is preferably subjected to heat treatment at a temperature of 300° C. or higher. By performing heat treatment (homogenization heat treatment) at such a high temperature, alloying elements contained in dendritic crystallized particles formed in the cast material can be dissolved into the matrix. The heat-treated material (solution-treated material) obtained by the heat treatment has a texture in which crystallized particles are spherical and small or substantially no crystallized particles exist. Such a texture is expected to contribute to improving plastic workability. More specifically, the heat treatment is performed under conditions of a temperature of 300° C. to 420° C. and a holding time of 1 to 100 hours.

The linear object according to an embodiment of the present invention may have a 0.2% proof stress of 200 MPa or more and a tensile strength of 260 MPa or more. The linear object according to another embodiment of the present invention may have an elongation of 4% or more. In particular, the linear object preferably has a 0.2% proof stress of 200 MPa or more, a tensile strength of 260 MPa or more, and an elongation of 4% or more.

The linear object of the present invention which has a specific composition and which is produced by performing plastic working, such as a drawing process, as described above has a high 0.2% proof stress, a high tensile strength, and excellent strength. Consequently, for example, when the linear object of the present invention is subjected to plastic working (forge processing, forming by rolling, or the like) for forming a bolt, it is possible to obtain a bolt having a high strength (axial force). Furthermore, the linear object of the present invention having an elongation of 4% or more can be sufficiently elongated at the time of plastic working, and therefore, fractures or the like are unlikely to occur and excellent plastic workability is exhibited. The higher the 0.2% proof stress, tensile strength, or elongation, the more preferable it is. The 0.2% proof stress is preferably 220 MPa or more, in particular, 240 MPa or more. The tensile strength is preferably 280 MPa or more, in particular, 300 MPa or more. The elongation is preferably 5% or more, in particular, 6% or more.

As described above, since the linear object of the present invention has excellent heat resistance and excellent plastic workability, it can be suitably used as a material for a secondary product which is subjected to plastic working. Examples of the plastic working include an extrusion process, a drawing process, forge processing, forming by rolling, heading, a rolling process, a press work, a bending work, and a drawing process. These working operations may be performed alone or in combination on the linear object of the present invention. Examples of the secondary product include, in addition to fastener components, such as bolts, nuts, and washers, shafts, pins, rivets, gears, sheets, pressed materials, aircraft parts, car parts, and components and casings for various electronic/electric appliances.

A bolt of the present invention is produced, for example, by forge processing in which a head portion is formed on a rod-shaped piece obtained by cutting a linear object of the present invention to a predetermined size, and forming by rolling in which a thread is formed on its shank.

A nut of the present invention is produced, for example, by heading in which a rod-shaped piece obtained by cutting a linear object of the present invention to a predetermined size is placed in a die and formed into a predetermined shape under an applied pressure while making a hole, and then cutting a thread in the hole.

A washer of the present invention is produced, for example, by subjecting a rod-shaped piece obtained by cutting a linear object of the present invention to a predetermined size to a press work or heading.

In the case where the bolt and the nut according to the present invention or the bolt, the nut, and the washer according to the present invention are combined to form a fastening structure, by using the components each composed of a magnesium alloy (preferably, magnesium alloy having the same composition), it is possible to suppress occurrence of electrical corrosion between these fastener components or loosening of the fastened state due to a difference in thermal expansion.

The surface of the bolt, the nut, or the washer according to an embodiment of the present invention may be provided with a coating which protects against corrosion.

By providing a coating on the surface of the bolt or the like, the magnesium alloy can be prevented from being corroded because of contact with corrosive components contained in the environment in which the bolt or the like is used, and the corrosion resistance of the bolt or the like can be improved. In addition to the fastener component, such as the bolt, the nut, or the washer, the surface of each of the shafts, pins, rivets, gears, sheets, pressed materials, aircraft parts, car parts, and components and casings for various electronic/electric appliances can also be provided with the coating.

A coating composed of a material that has corrosion resistance against corrosive components contained in the usage environment and having a structure that prevents entry of corrosive components can be suitably used as the coating. For example, an inorganic coating material or an organic coating material can be used as the coating, and from the viewpoint of heat resistance, durability, or the like, an inorganic coating material is preferably used. When the coating is provided on a component, such as a bolt, to which a stress (load) is applied during use, as necessary, an auxiliary composed of a ceramic, a metal, or a resin may be added to the coating in order to increase the strength of the coating.

A known coating technique may be used to provide the coating. As the coating material, for example, the DELTA series available from Doerken Corp. can be used.

Preferably, the thickness of the coating is 1 μm or more and less than 20 μm. At a thickness of 1 μm or more, sufficient corrosion resistance can be obtained. At a thickness of less than 20 μm, the dimensional accuracy of the component is unlikely to be affected.

When the coating is provided on the surface of a component, such as a bolt, by performing, as pretreatment, surface treatment, such as degrease treatment, chemical conversion treatment, shotblasting, or sandblasting, adhesiveness between the component and the coating can be improved. Furthermore, in the case where heat treatment is performed at the time of providing the coating, in consideration of thermal effect on the crystalline texture of the magnesium alloy constituting the component coated with the coating material, the temperature of the heat treatment is preferably set at lower than 250° C.

### Advantageous Effects of Invention

The linear object composed of a magnesium alloy according to the present invention has excellent heat resistance and excellent plastic workability and can be suitably used as a material for fastener components, such as bolts, nuts, and washers.

The bolt, the nut, and the washer according to the present invention have excellent heat resistance.

### BRIEF DESCRIPTION OF DRAWINGS

FIG. 1A is a micrograph (400 times) showing the metallographic structure of the magnesium alloy having the composition I, which is one of the compositions produced in Experimental Example 1, and showing a cast material.

FIG. 1B is a micrograph (400 times) showing the metallographic structure of the magnesium alloy having the composition I, which is one of the compositions produced in Experimental Example 1, and showing a homogenized material.

FIG. 1C is a micrograph (400 times) showing the metallographic structure of the magnesium alloy having the composition I, which is one of the compositions produced in Experimental Example 1, and showing an extruded material.

FIG. 1D is a micrograph (400 times) showing the metallographic structure of the magnesium alloy having the composition I, which is one of the compositions produced in Experimental Example 1, and showing a drawn material.

### DESCRIPTION OF EMBODIMENTS

Embodiments of the present invention will be described below.

### Experimental Example 1

[Production of Wires]

Elements were charged into crucibles so as to satisfy the compositions (mass %) shown in Table I. The resulting mixtures were melted in an electric furnace and poured into casting molds to form billets (cast materials) of magnesium alloys. The crucibles and the casting molds used were composed of high-purity carbon, and melting and casting were performed in an argon (Ar) gas atmosphere. Each of the billets had a cylindrical shape with a diameter φ of 80 mm and a length of 90 mm. Next, the surface of each billet was subjected to grinding to form a ground material having a diameter φ of 49 mm. Then, an extrusion process was performed on the ground material to produce a bar (extruded material) having a diameter φ of 13 mm. Table I also shows the number of atoms of additive elements of the compositions I to III. When the atomic ratios of the extruded materials produced using the compositions I to III were measured, the measured values were the same as the numerical values shown in Table I.

In the extrusion process, the working temperature is preferably set at 350° C. to 450° C. By setting the working temperature at 350° C. or higher, the plastic workability of the magnesium alloy is enhanced and occurrence of fractures or the like during working is likely to be prevented. As the working temperature is increased, plastic workability can be enhanced. However, if the working temperature exceeds 450° C., crystal grain growth proceeds to coarsen the crystal grains during the process, and there is a possibility that the coarsened structure will decrease plastic workability in the subsequent process. The extrusion ratio is preferably 5% to 20%. By setting the extrusion ratio at 5% or more, mechanical characteristics can be expected to be improved owning to deformation associated with the extrusion process. However, if the extrusion ratio exceeds 20%, there is a possibility that fractures, breaking, or the like will occur during working. When the cooling rate after extrusion is 0.1° C./sec or more, crystal grain growth can be suppressed, which is preferable. In order to increase the cooling rate after extrusion as described above, for example, a forced cooling means may be used. In this experiment, the extrusion process was performed under conditions of a working temperature of 385° C., an extrusion ratio of 15%, an extrusion rate of 0.2 mm/sec, and a cooling rate of 1° C./sec.

TABLE I

| | | | | | | |
|---|---|---|---|---|---|---|
| Composition | Mg | Zn | Ca | Al | Mn | Zr |

Components (mass %)

| | | | | | | |
|---|---|---|---|---|---|---|
| I | Bal. | 2.7 | 1.6 | — | — | — |
| II | Bal. | 2.7 | 1.6 | — | 0.2 | 1.0 |
| III | Bal. | 2.7 | 0.8 | — | — | — |
| IV | Bal. | 7.0 | 1.6 | — | — | — |
| V | Bal. | 0.9 | — | 2.8 | 0.1 | — |

Components (at %)

| | | | | | | |
|---|---|---|---|---|---|---|
| I | Bal. | 1.0 | 1.0 | — | — | — |
| II | Bal. | 1.0 | 1.0 | — | 0.1 | 0.3 |
| III | Bal. | 1.0 | 0.5 | — | — | — |

Each of the resulting magnesium alloy bars (extruded materials) was subjected to a drawing process to produce a wire rod (wire) having a diameter φ of 8.9 mm. Regarding the material having the composition IV with a high Zn content, breaking occurred during drawing, and it was not possible to obtain a wire rod having a sufficient length. Regarding the materials having any of the compositions Ito III and V, it was possible to obtain wire rods having a length that was 100 or more times the diameter φ. When the appearance of the resulting wire rods was visually confirmed, no defects, such as fractures, were observed.

In the drawing process, the working temperature is preferably set at 100° C. to 300° C. By setting the working temperature at 100° C. or higher, the plastic workability of the magnesium alloy is enhanced and occurrence of fractures, breaking, or the like during working is likely to be prevented. As the working temperature is increased, plastic workability can be enhanced. However, if the working temperature exceeds 300° C., grain growth proceeds to coarsen the crystal grains during working, and there is a possibility that the coarsened structure will decrease plastic workability in the subsequent process. In the drawing process, an appropriate number of drawing operations may be performed so that a wire rod having a desired final wire diameter can be obtained. The working ratio (reduction in area) per drawing operation is preferably 5% to 20%. By setting the working ratio per drawing operation at 5% or more, in particular 10% or more, mechanical characteristics can be expected to be improved owning to deformation associated with the working. However, if the working ratio per drawing operation exceeds 20%, there is a possibility that fractures, breaking, or the like will occur during working. When the cooling rate after drawing is 0.1° C./sec or more, crystal grain growth can be suppressed, which is preferable. In order to increase the cooling rate after drawing as described above, for example, a forced cooling means may be used or the drawing rate (linear velocity) may be adjusted.

In the case where the drawing process is performed multiple number of times, in particular, in the case where the total working ratio on the basis of the initial wire diameter and the final wire diameter exceeds 20%, it is preferable to perform intermediate heat treatment on the intermediate drawn material at an appropriate time when the total working ratio is 20% or less. By performing intermediate heat treatment, it is possible to remove the strain introduced into the intermediate drawn material by the drawing process up to the heat treatment, and a fine recrystallization texture can be obtained by removing the strain. By obtaining the heat-treated texture, it is likely that occurrence of fractures or breaking during the drawing process after the heat treatment can be prevented, and the drawing process with a total working ratio of more than 20% can be performed stably. Performing intermediate heat treatment on an intermediate plastic-worked material in the middle of plastic working including a drawing process as described above is expected to contribute to improving plastic workability.

The temperature of the intermediate heat treatment is preferably 100° C. to 450° C. At a temperature of lower than 100° C., strain cannot be removed sufficiently. As the temperature is increased, plastic workability tends to be enhanced. However, at a temperature of higher than 450° C., crystal grains are coarsened during the heat treatment, resulting in degradation in plastic workability after the intermediate heat treatment. In particular, the temperature of the intermediate heat treatment is preferably 300° C. or higher. Plastic workability is expected to be further improved by the heat treatment at such a high temperature even in the composition which includes Ca in a relatively large amount, such as more than 0.4% by mass, in particular, 1.0% by mass. The holding time is preferably 0.5 to 10 hours.

Heat treatment may be performed not only in the middle of the drawing process but also after the final drawing operation. By subjecting the drawn material with the final wire diameter to heat treatment, the strength and elongation of the wire rod can be adjusted to desired values. The final heat treatment may be performed, for example, under conditions of a temperature of 100° C. to 450° C. and a holding time of 0.5 to 10 hours.

In this experiment, a drawing process was performed multiple number of times under conditions of a working temperature of the drawing process of 250° C., a working ratio per drawing operation of 11% to 14%, a drawing rate (linear velocity) of 50 mm/sec, and a cooling rate after drawing of 1° C./sec. The total working ratio was 53%. Intermediate heat treatment was performed at 450° C. for one hour, and final heat treatment was performed at 350° C. for 1.5 hours.

[Evaluation of Properties of Wires]

Test pieces were taken from the resulting magnesium alloy wires having the respective compositions. A creep test was performed on the test pieces, and the creep property of each of the wires was evaluated. The creep test was performed according to JIS Z 2271 (1999), in which each test piece was held at 150° C. for 100 hours under an applied constant load (stress) of 75 MPa. The creep strain after 100 hours was measured to evaluate the creep property. The results thereof are shown in Table II.

Furthermore, the 0.2% proof stress, the tensile strength, and the elongation were measured for each wire. The results thereof are also shown in Table II. The 0.2% proof stress, the tensile strength, and the elongation were each measured at room temperature according to JIS Z 2241 (1998): Method of testing of metallic materials.

TABLE II

| | | Creep | 0.2% Proof | Tensile | Elonga- |
|---|---|---|---|---|---|
| | Composi- | strain | stress | strength | tion |
| No. | tion | (%) | (MPa) | (MPa) | (%) |
| 1-1 | I | 0.27 | 230 | 295 | 7 |
| 1-2 | II | 0.30 | 245 | 315 | 6 |
| 1-3 | III | 0.85 | 225 | 290 | 8 |
| 1-100 | IV | Unmea- | Unmea- | Unmea- | Unmea- |
| | | surable | surable | surable | surable |
| 1-110 | V | Ruptured | 200 | 270 | 8 |
| | | in 10 hr | | | |

As is obvious from Table II, in each of the wires of Sample Nos. 1-1 to 1-3 having the compositions Ito III in which the contents of Ca and Zn are in specific ranges, the creep strain is 1.0% or less, indicating excellent heat resistance (creep property). Furthermore, in each of the wires of Sample Nos. 1-1 to 1-3, the 0.2% proof stress is 200 MPa or more, and the tensile strength is 260 MPa or more, indicating excellent strength. Furthermore, the elongation is 4% or more, indicating excellent toughness. Consequently, each of the wires of Sample Nos. 1-1 to 1-3 is expected to have excellent plastic workability. In contrast, in Sample No. 1-100 in which the contents of Ca and Zn are outside the specific ranges, as described above, rupture occurs during drawing, indicating poor plastic workability. In Sample No. 1-110 which contains Zn only and does not contain Ca, rupture occurs in 10 hours in the creep test, which indicates that heat resistance is poor and strength is low compared with Sample Nos. 1-1 to 1-3.

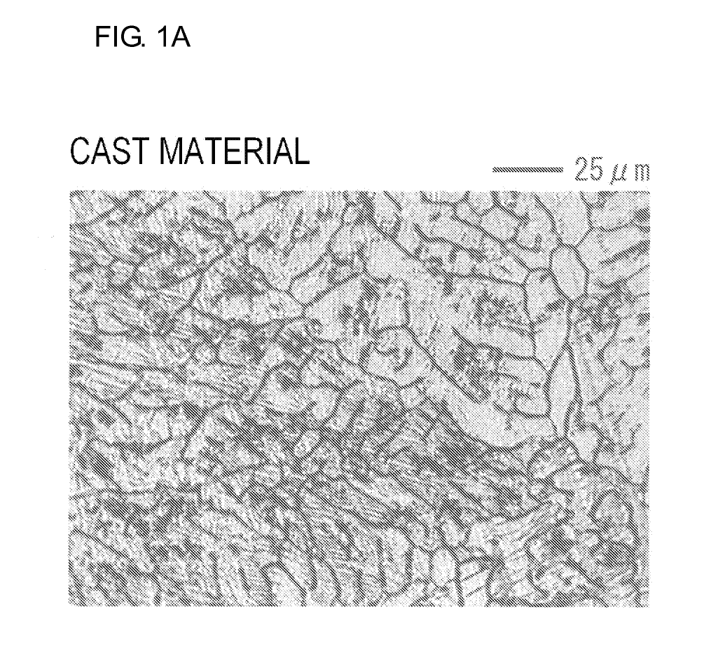

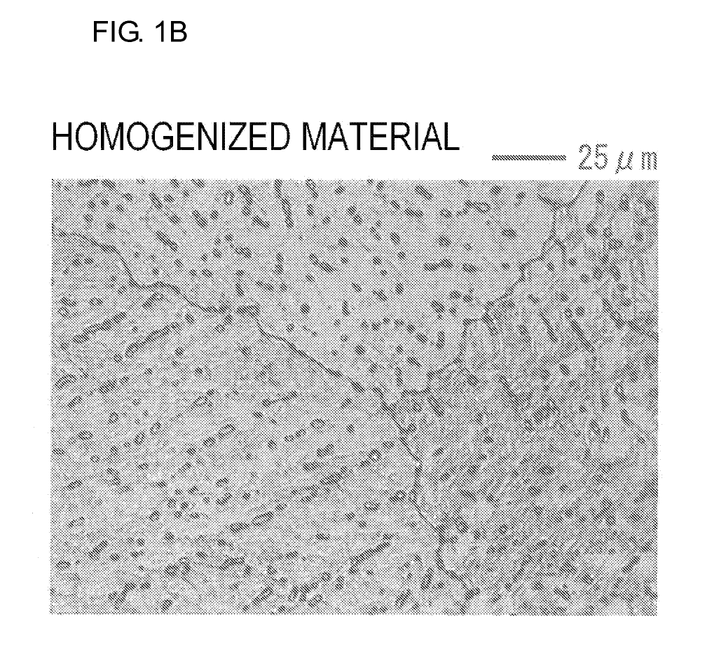

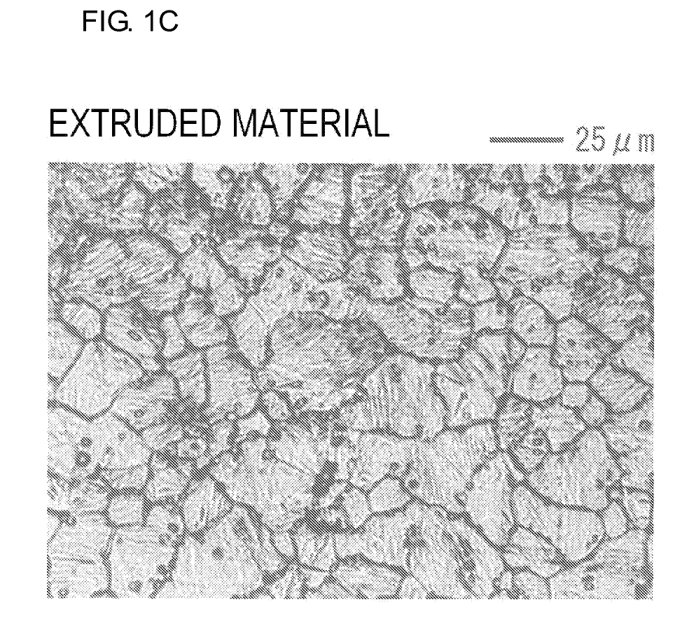

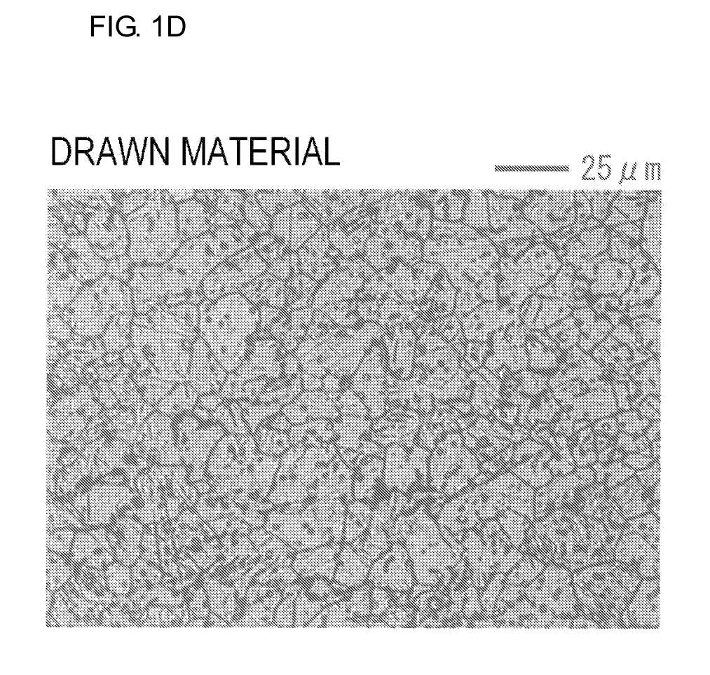

FIGS. 1A to 1D are micrographs showing cross sections of embodiments of produced Sample No. 1-1 having the composition I. In FIGS. 1B to 1D, the small granular material present in crystal grains and grain boundaries is mainly composed of crystallized particles (mainly, an intermetallic compound containing Ca and Mg). Here, a test piece was taken from a ground material (φ49 mm) obtained by grinding a cast material, and the test piece was subjected to homogenization treatment at 400° C. for 48 hours to produce a homogenized material. In the cast material shown in FIG. 1A, dendritic crystallized particles, i.e., portions which appear dark (black), are present. In contrast, as shown in FIG. 1B, by subjecting the cast material to homogenization heat treatment, some of the crystallized particles are dissolved into the matrix, and the rest are spherical and small. In the extruded material and the drawn material shown in FIGS. 1C and 1D, fine granular crystallized or precipitated particles are uniformly dispersed. That is, by performing homogenization heat treatment or plastic working such as, extrusion, or drawing, a texture is produced in which crystallized or precipitated particles are refined. The magnesium alloy linear objects shown in FIGS. 1B to 1D, which have such a texture, are expected to have excellent plastic workability, such as forging, forming by rolling, or the like. Furthermore, the extruded material or the drawn material, which has been subjected to plastic working, has fine crystal grains. In particular, the drawn material has very fine, uniform crystal grains compared with the extruded material. The drawn material is expected to have more excellent plastic workability because it has such a fine crystal texture.

[Preparing of Bolts]

Each of the produced wires composed of the magnesium alloys (Sample Nos. 1-1 to 1-3 & 1-110) was cut into a piece having a predetermined size, the resulting rod-shaped piece was subjected to forge processing to form a bolt head and then subjected to forming by rolling to form a thread. Thereby, bolts corresponding to M10 were produced. Here, the temperature of the forge processing was 350° C., and the temperature of the forming by rolling was 190° C.

[Preparing of Nuts]

Each of the produced wires (Sample Nos. 1-1 to 1-3 & 1-110) was cut into a piece having a predetermined size, the resulting rod-shaped piece was subjected to heading to be formed into a hexagonal shape while making a hole, and then a thread was cut in the hole. Thereby, nuts were produced. Here, the heading temperature was 350° C., and the cutting of the thread was performed at room temperature.

[Evaluation of Properties of Bolts]

The axial force relaxation test described below was carried out on the resulting magnesium alloy bolts having the respective compositions, and the axial force relaxation property of each bolt was evaluated.

The axial force relaxation test was carried out in the following manner. A magnesium alloy sheet having a bolt hole was prepared. The bolt was inserted into the bolt hole and tightened with a nut having the same composition as the bolt and fabricated as described above. In this stage, the elongation of the bolt was measured with an ultrasonic bolt force meter (BOLT-MAX II manufactured by TMI DAKOTA Co., Ltd.) before and after the tightening. The initial axial force was calculated from the change in bolt length and a Young's modulus. The Young's modulus was determined from a tensile test of the wire. The change in bolt length (degree of tightening of the bolt) was adjusted such that the initial axial force was 90 MPa. Next, the sheet was held at 150° C. for 24 hours with the bolt being tightened at an initial axial force of 90 MPa, and was cooled to room temperature. Then, the bolt was removed. In this stage, the elongation of the bolt was measured with the ultrasonic bolt force meter before and after the removal. The residual axial force was calculated from the change in bolt length and the Young's modulus.

The axial force relaxation rate of each bolt was calculated from the expression below on the basis of the initial axial force and the residual axial force determined from the axial force relaxation test to evaluate the axial force relaxation property. The results thereof are shown in Table III. Note that, in a bolt having a lower axial force relaxation rate, the fastened state is less likely to be loosened, and such a bolt has a better axial force relaxation property and is advantageous.

Axial force relaxation rate=(initial axial force−residual axial force)/initial axial force

TABLE III

| | | Initial | Residual | Axial force |
|---|---|---|---|---|
| | Composi- | axial force | axial force | relaxation |
| No. | tion | (MPa) | (MPa) | rate (%) |
| 1-1 | I | 90 | 77 | 14 |
| 1-2 | II | 90 | 76.5 | 15 |
| 1-3 | III | 90 | 61 | 32 |
| 1-100 | IV | Unmea- | Unmea- | Unmea- |
| | | surable | surable | surable |
| 1-110 | V | 90 | 6 | 93 |

As is obvious from Table III, in each of the bolts made from the wires of Sample Nos. 1-1 to 1-3 having the contents of Ca and Zn in specific ranges, the axial force relaxation rate is low, indicating an excellent axial force relaxation property. Therefore, the bolts made from the wires of Sample No. 1-1 to 1-3 can maintain a high axial force even when used in a high-temperature environment. It is expected that loosening due to a decrease in the axial force will be unlikely to occur. In contrast, in the bolt made from the wire of sample No. 1-110 which contains Zn only and does not contain Ca, the axial force relaxation rate is 90% or more, and there is a possibility that the axial force will be decreased, causing the bolt to be loosened when used in a high-temperature environment. Thus, it is believed that the bolt cannot sufficiently withstand use in a high-temperature environment. Furthermore, the axial force relaxation rate is preferably 50% or less and more preferably 30% or less, in particular, 20% or less.

As the embodiments of the present invention, the linear object (wire) composed of a magnesium alloy, and the bolt and the nut produced using, as a material, the linear object have been described above. The linear object of the present invention can be suitably used as a material for other components, such as washers.

The embodiments can be appropriately modified within a range not departing from the gist of the present invention, and are not limited to the structures described above. For example, the composition of magnesium alloys (kinds of additive elements, contents), the cross-sectional shape and the size of the linear object, and the like may be changed appropriately. Furthermore, a corrosion-resistant protective coating may be provided on the surfaces of bolts, nuts, and washers.

### INDUSTRIAL APPLICABILITY

The linear object composed of a magnesium alloy according to the present invention has excellent heat resistance and excellent plastic workability, and can be suitably used as a material for secondary products obtained by performing plastic working, for example, fastener components, such as bolts, nuts, and washers. The bolt, the nut, and the washer of the present invention can be suitably used for fastening various members, in particular, members composed of a magnesium alloy.

1. A linear object comprising a magnesium alloy,
the magnesium alloy including 0.1% by mass or more and 6% by mass or less of Zn, more than 0.4% by mass and 4% by mass or less of Ca, and the balance being Mg and incidental impurities, the linear object having a 0.2% proof stress of 200 MPa or more and a tensile strength of 260 MPa or more,
the linear object having a creep strain of 1.0% or less, when a creep test is performed on the linear object under conditions of a temperature of 150° C., a stress of 75 MPa, and a holding time of 100 hours.

2. A linear object comprising a magnesium alloy,
the magnesium alloy including 0.1% by mass or more and 6% by mass or less of Zn, more than 0.4% by mass and 4% by mass or less of Ca, at least one element selected from the group consisting of 0.1% by mass or more and 6% by mass or less of Al, 0.1% by mass or more and 6% by mass or less of Sn, 0.01% by mass or more and 2% by mass or less of Mn, 0.01% by mass or more and 2% by mass or less of Si, 0.01% by mass or more and 4% by mass or less of Zr, and 0.01% by mass or more and 4% by mass or less of Sr, and the balance being Mg and incidental impurities, the linear object having a 0.2% proof stress of 200 MPa or more and a tensile strength of 260 MPa or more,
the linear object having a creep strain of 1.0% or less, when a creep test is performed on the linear object under conditions of a temperature of 150° C., a stress of 75 MPa, and a holding time of 100 hours.

3. The linear object comprising a magnesium alloy according to claim 1, wherein the atomic ratio of Zn to Ca satisfies the expression Zn:Ca=1:0.5 to 2.

4. (canceled)

5. The linear object comprising a magnesium alloy according to claim 1, wherein the linear object has an elongation of 4% or more.

6. A bolt produced by subjecting the linear object comprising a magnesium alloy according to claim 1 to plastic working.

7. A nut produced by subjecting the linear object comprising a magnesium alloy according to claim 1 to plastic working.

8. A washer produced by subjecting the linear object comprising a magnesium alloy according to claim 1 to plastic working.
